(19) United States
(12) Patent Application Publication
(10) Pub. No.: US 2023/0025402 A1
(43) Pub. Date: Jan. 26, 2023

(54) REFRIGERATION DEVICE AND OPERATING METHOD THEREFOR

(71) Applicant: Rheem Manufacturing Company, Atlanta, GA (US)

(72) Inventor: Yang Zou, Frisco, TX (US)

(21) Appl. No.: 17/382,414

(22) Filed: Jul. 22, 2021

(51) Int. Cl. F25B 47/02; F25B 49/02; H05B 6/64; H05B 6/68; H05B 6/80

(52) U.S. Cl. CPC F25B 47/02; F25B 49/02; H05B 6/6452; H05B 6/688; H05B 6/802; F25B 2700/21172; F25B 2400/01; H05B 2214/02; F25B 2600/00

(57) ABSTRACT

The present disclosure provides a refrigeration device including a circuit having an evaporator, a compressor, a condenser, and an expansion valve orderly connected by a refrigerant flow path. The refrigeration device further includes a first sensor to sense ambient temperature, second sensor to sense evaporator inlet temperature, a microwave module disposed proximal to the evaporator to generate microwaves, and a controller coupled to the first sensor, the second sensor and the microwave module. The controller determines whether a difference in temperature value between the ambient temperature and the evaporator inlet temperature is equal to or greater than a first predetermined temperature value, and initiates operation of the microwave module to heat an inlet of the evaporator when the difference in temperature value between the ambient temperature and the evaporator inlet temperature is equal to or greater than the first predetermined temperature value.

### TECHNICAL FIELD

The present disclosure relates, in general, to a refrigeration device and, more specifically relates, to a defrost control method of an evaporator of the refrigeration device.

### BACKGROUND

Refrigeration devices, such as air conditioners, are conventionally utilized to adjust temperature within dwellings structures, such as house and offices. In a split-type air conditioner, an indoor unit is located indoors, and an outdoor unit is located outdoors. A frequently encountered challenge with such air conditioners lies with defrosting the outdoor unit, particularly during winter condition where the outdoor unit functions as an evaporator. For example, when the evaporator is active, frost may accumulate on the evaporator and thereby reduce efficiency of the evaporator. In cases where zeotropic refrigerant blends are used as operating fluid in the split-type air conditioner, temperature at an inlet of the evaporator is lower than temperature at an outlet of the evaporator. Hence, amount of frost accumulation at the inlet may be greater than at the outlet of the evaporator.

When the frost formation on the evaporator is not addressed at its beginning, the frost may accumulate on the evaporator over time, and may eventually block air flow across the evaporator, thereby reducing heat transfer efficiency of the evaporator. Known solutions to mitigate the frost formation include electric heating devices disposed within the outdoor unit. However, only a small proportion of heat generated from such electric heating devices is used to melt the frost, while major proportion of the generated heat is lost to air and other components in the outdoor unit. Instances of uncontrolled heating may damage the electric heating devices and may result in repeated defrost cycles unnecessarily.

### SUMMARY

According to one aspect of the present disclosure, a refrigeration device is disclosed. The refrigeration device includes a circuit comprising an evaporator, a compressor, a condenser, and an expansion valve orderly connected by a refrigerant flow path. The refrigeration device further includes a first sensor configured to sense ambient temperature, a second sensor configured to sense evaporator inlet temperature, at least one microwave module disposed proximal to the evaporator and configured to generate microwaves, and a controller coupled to each of the first sensor, the second sensor, and the microwave module. In an embodiment, the microwave module is disposed proximal to the inlet of the evaporator and around a fan motor of the evaporator. In some embodiments, the microwave module includes a magnetron, a transformer, a diode, and a capacitor. Further, the controller is configured to determine whether a difference in temperature value between the ambient temperature and the evaporator inlet temperature is equal to or greater than a first predetermined temperature value and initiate operation of the microwave module to heat an inlet of the evaporator when the difference in temperature value between the ambient temperature and the evaporator inlet temperature is equal to or greater than the first predetermined temperature value.

In an embodiment, the controller is configured to cease the operation of the microwave module when the difference in temperature value between the ambient temperature and the evaporator inlet temperature is less than the first predetermined temperature value.

In some embodiments, the first sensor is disposed on a periphery of the evaporator. In some embodiments, the controller is configured to initiate the operation of the microwave module when the ambient temperature is less than a predefined ambient temperature value. In an embodiment, the predefined ambient temperature value is about 32° F. In some embodiments, the controller is configured to determine whether a predefined time period has elapsed prior to actuation of the at least one microwave module for a subsequent defrost of the inlet of the evaporator. In a preferred embodiment, the controller is configured to initiate the operation of the microwave module when: (a) the difference in temperature value between the ambient temperature and the evaporator inlet temperature is equal to or greater than the first predetermined temperature value, (b) the ambient temperature is less than the predefined ambient temperature value, such as 32° F., and (c) the predefined time period has elapsed with respect to the previous defrost cycle for the inlet of the evaporator.

In some embodiments, the refrigeration device further includes a third sensor configured to sense evaporator outlet temperature, and a four-way valve disposed between the evaporator and the compressor. The controller is coupled to the third sensor and the four-way valve. The controller is configured to determine whether a difference in temperature value between the ambient temperature and the evaporator outlet temperature is greater than a second predetermined temperature value, and control operation of the four-way valve to initiate a defrost cycle to heat the outlet of the evaporator when the difference in temperature value between the ambient temperature and the evaporator outlet temperature is greater than the second predefined temperature value. In some embodiments, the controller is configured to control operation of the four-way valve to cease the defrost cycle when the difference in temperature value between the ambient temperature and the evaporator outlet temperature is less than the second predetermined temperature value.

In some embodiments, the refrigeration device further includes a first frost sensor disposed proximal to the inlet of the evaporator. The controller is coupled to the first frost sensor and configured to initiate operation of the microwave module based on an input from the first frost sensor to defrost the inlet of the evaporator. In some embodiments, the refrigeration device further includes a second frost sensor disposed proximal to the outlet of the evaporator. The controller is coupled to the second frost sensor and configured to control operation of the four-way valve to initiate the defrost cycle to defrost the outlet of the evaporator, based on an input from the second frost sensor. In some embodiments, the controller is configured to determine whether a predefined time period has elapsed prior to initiation of the defrost cycle by the four-way valve for the subsequent defrost of the outlet of the evaporator. In a preferred embodiment, the controller is configured to initiate the defrost cycle when (a) the difference in temperature value between the ambient temperature and the evaporator outlet temperature is greater than the second predetermined temperature value, (b) the ambient temperature is less than the predefined ambient temperature value, such as 32° F., and (c) the predefined time period has elapsed with respect to the previous defrost cycle for the outlet of the evaporator.

According to another aspect of the present disclosure, a method of operating a refrigeration device is disclosed. The method includes receiving, by a controller, a first input from a first sensor and a second input from a second sensor. The first input is indicative of ambient temperature, and the second input is indicative of evaporator inlet temperature. The method further includes determining, by the controller, whether a difference in temperature value between the ambient temperature and the evaporator inlet temperature is greater than a first predetermined temperature value. The method further includes initiating, by the controller, operation of at least one microwave module to heat an inlet of the evaporator when the difference in temperature value between the ambient temperature and the evaporator inlet temperature is greater than the first predetermined temperature value.

In some embodiments, the method includes initiating, by the controller, operation of the at least one microwave module when the ambient temperature is less than a predefined ambient temperature value.

In some embodiments, the method includes receiving, by the controller, an input from a first frost sensor disposed proximal to the inlet of the evaporator, and initiating, by the controller, the operation the at least one microwave module based on the input from the first frost sensor to defrost the inlet of the evaporator. In some embodiments, the method includes determining, by the controller, whether a predefined time period has elapsed prior to actuation of the at least one microwave module for a subsequent defrost of the inlet of the evaporator.

In some embodiments, the method further includes receiving, by the controller, a third input from a third sensor indicative of evaporator outlet temperature, and determining, by the controller, whether a difference in temperature value between the ambient temperature and the evaporator outlet temperature is greater than a second predetermined temperature value. When the controller determines the difference in temperature value between the ambient temperature and the evaporator outlet temperature being greater than the second predetermined temperature value, the method includes controlling, by the controller, operation of the four-way valve to initiate a defrost cycle to heat the outlet of the evaporator. In some embodiments, the method includes receiving, by the controller, an input from a second frost sensor disposed proximal to the outlet of the evaporator and controlling the operation of the four-way valve to initiate the defrost cycle to defrost the outlet of the evaporator, based on the input from the second frost sensor.

These and other aspects and features of non-limiting embodiments of the present disclosure will become apparent to those skilled in the art upon review of the following description of specific non-limiting embodiments of the disclosure in conjunction with the accompanying drawings.

### BRIEF DESCRIPTION OF THE DRAWINGS

A better understanding of embodiments of the present disclosure (including alternatives and/or variations thereof) may be obtained with reference to the detailed description of the embodiments along with the following drawings, in which:

FIG. 1 is a schematic diagram of a refrigeration device;

FIG. 2 is a schematic diagram of an outdoor unit of the refrigeration device, according to an embodiment of the present disclosure;

FIG. 3 is a schematic diagram of a defrost control arrangement, according to an embodiment of the present disclosure;

FIG. 4 is a schematic diagram of a defrost control arrangement 300, according to another embodiment of the present disclosure;

FIG. 5A is a flowchart of a method of operating the refrigeration device, according to an embodiment of the present disclosure; and

FIG. 5B is a flowchart of a method of operating the refrigeration device, according to another embodiment of the present disclosure.

### DETAILED DESCRIPTION

Reference will now be made in detail to specific embodiments or features, examples of which are illustrated in the accompanying drawings. Wherever possible, corresponding, or similar reference numbers will be used throughout the drawings to refer to the same or corresponding parts. Moreover, references to various elements described herein, are made collectively or individually when there may be more than one element of the same type. However, such references are merely exemplary in nature. It may be noted that any reference to elements in the singular may also be construed to relate to the plural and vice-versa without limiting the scope of the disclosure to the exact number or type of such elements unless set forth explicitly in the appended claims.

As used herein, the terms “a”, “an” and the like generally carry a meaning of “one or more,” unless stated otherwise. Further, the terms “approximately”, “approximate”, “about”, and similar terms generally refer to ranges that include the identified value within a margin of 20%, 10%, or preferably 5%, and any values therebetween.

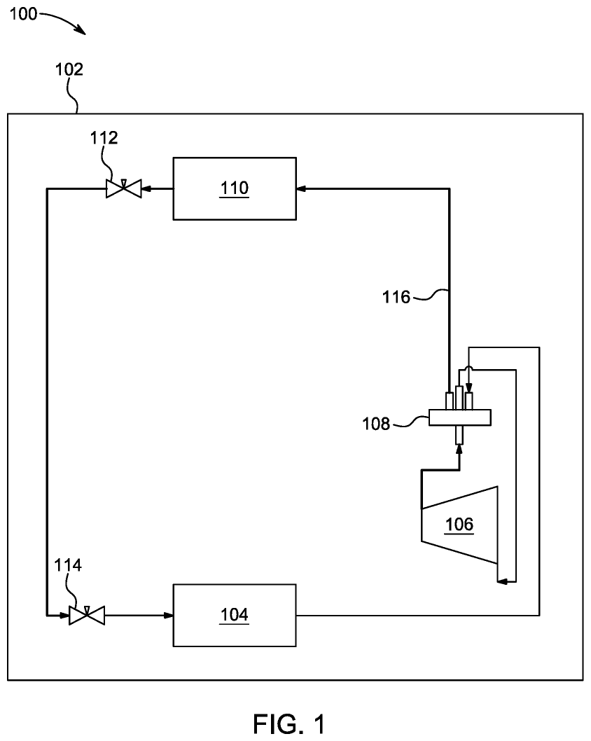

Aspects of the present disclosure are directed to a refrigeration device implementing a controlled defrost cycle of an evaporator thereof, which includes localized heating of portions of evaporator affected with frost, thereby minimizing energy consumed by the defrost cycle. Additionally, the present disclosure mitigates effects of non-uniform frost accumulation caused by zeotropic refrigerant glide. Referring to FIG. 1, a schematic diagram of a refrigeration device 100 implementing a circuit 102 is illustrated. For the purpose of the present disclosure, the refrigeration device 100 is considered as an air conditioner, preferably a split-type air conditioner where an outdoor unit of the air conditioner is located outside a building and an indoor unit is disposed within an indoor space of the building. However, the aspects of the present disclosure may be implemented in any other type of air conditioner, such as an industrial packaged air conditioner, or any refrigeration device.

The circuit 102 includes an evaporator 104, a compressor 106, a four-way valve 108, a condenser 110, and a first expansion valve 112, and a second expansion valve 114 orderly connected by a refrigerant flow path 116. In an embodiment, the circuit 102 includes a zeotropic refrigerant blend, such as a mixture of two or more refrigerants selected from a group including, but not limited to, R-454A, R-454B, R-454C, R-407C, R-407F, and R-407H, flowing along the refrigerant flow path 116. As such, at same pressure level, each component in the zeotropic refrigerant blend has a different dew point temperatures. In cases where ambient temperature is low, for example during winter season, the refrigeration device 100 is configured to operate in a space heating mode. As used herein, the term ‘space heating’ refers to heating the indoor space of the building, where the outdoor unit functions as the evaporator 104 and the indoor unit functions as the condenser 110. The refrigerant flowing through the evaporator 104 is associated with a temperature less than ambient air and hence absorbs heat from the ambient air. Such absorption of the heat allows conversion of liquid refrigerant to vapor refrigerant. The vapor refrigerant flows into the compressor 106, via the four-way valve 108. At the compressor 106, the vapor refrigerant is compressed under high pressure, resulting in increase of temperature thereof. Heated vapor refrigerant flows through the condenser 110, where the vapor refrigerant loses heat to air in the indoor space, thereby heating the indoor space and partially condensing to liquid form. Further, partially condensed warm liquid refrigerant bypasses the first expansion valve 112 and further flows through the second expansion valve 114, where the pressure and temperature associated with the refrigerant is reduced for subsequent space heating cycle. With further fall in temperature of the ambient air, moisture present in the ambient air condenses on the evaporator 104, resulting in formation of frost. Since the refrigerant mixture has a lower saturation temperature at an inlet of the evaporator 104 than at an outlet thereof for same pressure level, frost formation may be higher at the inlet when compared to the outlet of the evaporator 104.

It will be understood that the refrigeration device 100 may be configured to operate in a cooling mode. As used herein, the term ‘cooling mode’ refers to cooling the indoor space, where the outdoor unit functions as the condenser 110 and the indoor unit functions as the evaporator 104. In such cooling mode, operation cycle illustrated in FIG. 1 is reversed, where the refrigerant flows in an opposite direction along the refrigerant flow path 116. In the cooling mode, the refrigerant bypasses the second expansion valve 114, and pressure and temperature associated with the refrigerant is reduced at the first expansion valve 112, thereby allowing complete condensation thereof.

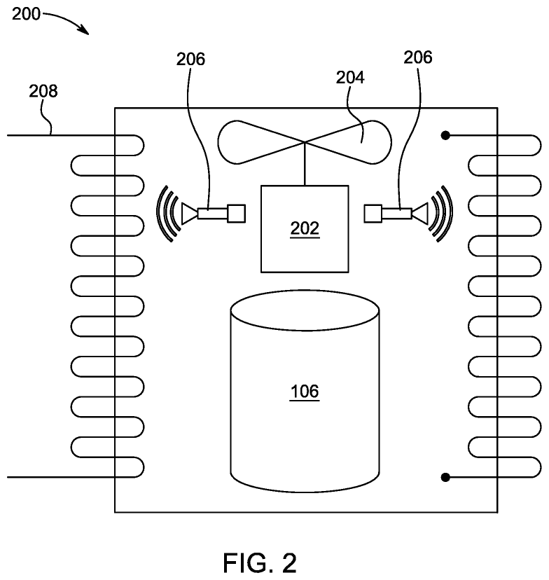

FIG. 2 illustrates a schematic diagram of the outdoor unit 200 including the evaporator 104, the compressor 106, a fan motor 202, and fan blades 204 connected to the fan motor 202. According to an embodiment of the present disclosure, the refrigeration device 100 includes at least one microwave module 206 disposed proximal to the evaporator 104. Particularly, in an embodiment, the microwave module 206 is disposed proximal to an inlet 208 of the evaporator 104 and configured to generate microwaves. As shown in FIG. 2, two or more microwave modules 206 may be disposed around the fan motor 202, such that the generated microwaves may be directed towards tubes of the evaporator 104. Power required to operate the microwave modules 206 may be supplied from a power source of the outdoor unit 200. It will be understood by a person skilled in the art that the outdoor unit 200 may include structures capable of disposing the microwave module 206 proximal to the inlet 208 of the evaporator 104.

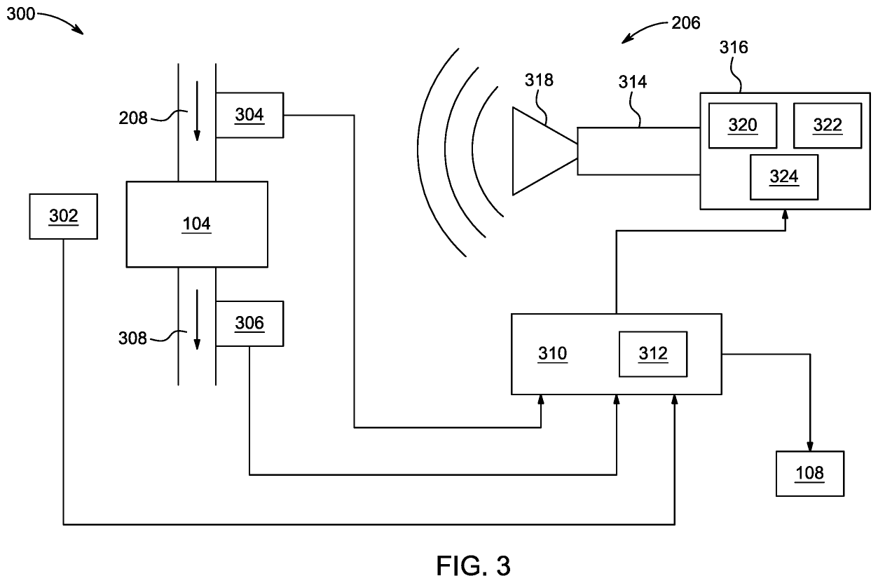

FIG. 3 illustrates a schematic diagram of a defrost control arrangement 300. In an embodiment, the refrigeration device 100 includes a first sensor 302 disposed along a periphery of the evaporator 104, a second sensor 304 coupled to an inlet 208 of the evaporator 104, a third sensor 306 coupled to an outlet 308 of the evaporator 104, and a controller 310 coupled to each of the first sensor 302, the second sensor 304, the third sensor 306, and the at least one microwave module 206. The second sensor 304 and the third sensor 306 are provided to determine saturation temperature of the refrigerant at the inlet 208 and the outlet 308 of the evaporator 104, respectively. However, since the saturation temperature of the refrigerant varies along a path from the inlet 208 to the outlet 308, determination of actual location of frost formation at the inlet 208 and the outlet 308 may be challenging. In order to address such challenges, the evaporator 104 is considered in two zones, namely an inlet zone and an outlet zone. The second sensor 304 and the third sensor 306 may be disposed in a middle of the inlet zone and the outlet zone, respectively. As such, the arrangement shown in FIG. 3 should not be considered as limiting.

In some embodiments, the controller 310 may be implemented as a processor, such as one or more microprocessors, microcomputers, digital signal processors, central processing units, state machines, logic circuitries, or any devices that manipulate signals based on operational instructions. Among other capabilities the processor may be configured to fetch and execute computer-readable instructions stored in a memory 312 thereof. Various functions of the processor may be provided using dedicated hardware as well as hardware capable of executing software in association with appropriate software. When provided by the processor, the functions may be provided by a single dedicated processor, by a single shared processor, or by a plurality of individual processors. Moreover, explicit use of the term “processor” should not be construed to refer exclusively to hardware capable of executing software, and may implicitly include, but not limited to, digital signal processor (DSP) hardware, network processor, application specific integrated circuit (ASIC), field programmable gate array (FPGA), read only memory (ROM) for storing software, random access memory (RAM), and non-volatile storage. Other hardware known to a person skilled in the art may also be included. In some embodiments, the controller 310 may be located in the indoor space and may include a user interface (not shown).

In an embodiment, the microwave module 206 includes a magnetron 314, a power unit 316, and an antenna 318. The power unit 316, amongst other components, includes a transformer 320, a diode 322, and a capacitor 324. The transformer 320, such as a linear transformer, functions as an electronic power converter to supply energy and drive the magnetron 314. The capacitor 324, such as a high voltage capacitor, is connected to the magnetron 314 and the transformer via the diode 322. The magnetron 314 is configured to convert high voltage electrical energy to microwave radiation.

Further, the first sensor 302 is configured to sense ambient temperature ‘T_{Amb}’ and the controller 310 is configured to receive a first input from the first sensor 302 indicative of the ambient temperature ‘T_{Amb}’. The space heating of the indoor space is required when temperature of the indoor space is low, for example during winter season. Additionally, possibility of frost development at the inlet 208 of the evaporator 104 may be high during the winter condition, for example when the ambient temperature ‘T_{Amb}’ is low. Accordingly, in an embodiment, based on the first input, the controller 310 is configured to determine whether the ambient temperature ‘T_{Amb}’ is less than a predefined ambient temperature value ‘T_{P-Amb}’ and actuate the microwave module 206 when the ambient temperature ‘T_{Amb}’ is less than the predefined ambient temperature value ‘T_{P-Amb}’. In an embodiment, the predefined ambient temperature value ‘T_{P-Amb}’ may be about 32° F., which is the freezing point of water, and may be stored in the memory 312 of the controller 310. Since the controller 310 is coupled to the first sensor 302 to receive the first input, the controller 310 may be configured to constantly determine whether the ambient temperature ‘T_{Amb}’ is less than the predefined ambient temperature value ‘T_{P-Amb}’. The ambient temperature ‘T_{Amb}’ being less than the predefined ambient temperature value ‘T_{P-Amb}’ such as 32° F., may be considered as an initial condition to be met for initiating a defrost cycle.

In some embodiments, the first sensor 302 may be located within the indoor space and may be configured to sense temperature of the indoor space. In such an arrangement, the controller 310 may be configured to initiate operation of the microwave module 206 when the temperature of the indoor space is less than a desired temperature. In an example, the desired temperature may be set by the user via the user interface.

Further, the controller 310 is configured to receive a second input from the second sensor 304 indicative of evaporator inlet temperature ‘T_{Inlet}’. Based on the second input, the controller 310 is configured to determine whether a difference in temperature value between the ambient temperature ‘T_{Amb}’ and the evaporator inlet temperature ‘T_{Inlet}’ is equal to or greater than a first predetermined temperature value ‘T₁’. When the difference in temperature value (T_{Amb}−T_{Inlet}) is greater than the first predetermined temperature value ‘T₁’, the controller 310 is configured to initiate operation of the microwave module 206 to heat the inlet 208 of the evaporator 104. As such, the defrost cycle begins when a second condition is met for initiating the defrost cycle, that is when the difference in temperature value (T_{Amb}−T_{Inlet}) is greater than the first predetermined temperature value ‘T₁’.

For example, the first predetermined temperature value ‘T₁’ may be about 30° F. and may be preset in the memory 312 of the controller 310. When the first condition is met and the second condition is not met, the controller 310 may not initiate the defrost cycle to heat the inlet 208 of the evaporator 104. In cases where the ambient temperature ‘T_{Amb}’ is below 32° F. and a relative humidity of ambient air is low, little or no moisture may accumulate on the inlet 208 of the evaporator 104. As such, the difference in temperature value (T_{Amb}−T_{Inlet}) may not reach the first predetermined temperature value ‘T₁’. For example, when the ambient temperature ‘T_{Amb}’ is 28° F. and the evaporator inlet temperature ‘T_{Inlet}’ is about 15° F., the difference in temperature value (T_{Amb}−T_{Inlet}) is about 13° F., which is less than the first predetermined temperature value ‘T₁’ of about 30° F. As frost accumulates on the inlet 208 of the evaporator 104, the evaporator inlet temperature ‘T_{Inlet}’ falls while the ambient temperature ‘T_{Amb}’ may remain constant. When the evaporator inlet temperature ‘Tinto.’ is about −2° F., the difference in temperature value (T_{Amb}−T_{Inlet}) reaches 30° F., which is equal to the first predetermined temperature value ‘T₁’ and indicative of a condition of frost formation at the inlet 208 of the evaporator 104. In such a condition, the controller 310 initiates the operation of the microwave module 206, where the antenna 318 amplifies and emanates electron energy at a predefined frequency towards the inlet 208 of the evaporator 104, thereby generating heat. With such arrangement, localized heating at the inlet 208 of the evaporator 104 may be achieved.

With such supply of heat, frost at the inlet 208 of the evaporator 108 may be reduced, thereby reducing the evaporator inlet temperature ‘T_{Inlet}’. When the difference in temperature value (T_{Amb}−T_{Inlet}) falls below the first predetermined temperature value ‘T₁’, the controller 310 is configured to cease the operation of the microwave module 206. In cases where multiple microwave modules 206 are deployed in the outdoor unit 200, the controller 310 may be configured to simultaneously actuate all the microwave modules 206. As such, uniform heating of the inlet 208 of the evaporator 104 may be achieved and localized defrost of the inlet 208 of the evaporator 104 may be ensured. As such, radiation of heat to neighboring components of the outdoor unit 200 may be eliminated, besides reducing power consumption to operate the microwave module 206. In some embodiments, the microwave modules 206 may be oriented in a manner to heat the evaporator tubes at a topmost portion of the outdoor unit 200 which may experience minimum flow of ambient air based on configuration of the fan blades 204. In some embodiments, the controller 310 may be configured to determine whether the second condition is met for initiating the defrost cycle, that is when the difference in temperature value (T_{Amb}−T_{Inlet}) is greater than the first predetermined temperature value ‘T₁’, without necessarily checking whether the first condition is met.

In some embodiments, as a third condition, the controller 310 may be configured to determine whether a predefined time period has elapsed prior to actuation of the microwave module 206 for a subsequent defrost of the evaporator 104. Such predefined time period may eliminate possibility of any false actuation of the microwave module 206 which may lead to unnecessary heating of the evaporator 104 and power utilization. In a preferred embodiment, the controller 310 is configured to initiate the operation of the microwave module 206 only when: (a) the difference in temperature value between the ambient temperature ‘T_{Amb}’ and the evaporator inlet temperature ‘T_{Inlet}’ is equal to or greater than the first predetermined temperature value ‘T₁’, (b) the ambient temperature ‘T_{Amb}’ is less than the predefined ambient temperature value ‘T_{P-Amb}’, such as 32° F., and (c) a predefined time period has elapsed with respect to a previous defrost cycle for the inlet 208 of the evaporator 104. In other words, the controller 310 is configured to initiate the operation of the microwave module 206 only when the first, the second, and the third condition is met.

Further, the third sensor 306 is configured to sense evaporator outlet temperature ‘T_{Outlet}’. The controller 310 is configured to receive a third input from the third sensor 308 indicative of the evaporator outlet temperature ‘T_{Outlet}’. Based on the third input, the controller 310 may be configured to determine a difference in temperature value between the ambient temperature ‘T_{Amb}’ and the evaporator outlet temperature ‘T_{Outlet}’ and determine whether the difference in temperature value (T_{Amb}−T_{Outlet}) is greater than a second predetermined temperature value ‘T₂’. The controller 310 may be further configured to control operation of the four-way valve 108 (See FIG. 1) to initiate the defrost cycle to heat the outlet 308 of the evaporator 104 when the difference in temperature value (T_{Amb}−T_{Outlet}) is greater than the second predetermined temperature value ‘T₂’. The localized defrost, that is the defrost of the inlet 208 of the evaporator 108 achieved with aid of the microwave module 206, improves heat transfer at the inlet 208 of the evaporator 108 and saves energy by delaying a need for the controller 310 to switch operation of the four-way valve 108 to initiate the defrost cycle. However, it will be understood that frost may accumulate and the switching of the four-way valve 108 to function in the defrost mode to heat the outlet 308 of the evaporator may take place eventually.

With the aid of the four-way valve 108, pressurized refrigerant associated with high temperature is directed to the outdoor unit 200 where the refrigerant loses heat to the evaporator 104, thereby melting the frost at the outlet 308 of the evaporator 104. During such operation, the controller 310 may be configured to cease operation of the fan motor 202 to minimize flow of cold ambient air across the evaporator 104 and reduce additional heat loss from the refrigerant flowing across the evaporator 104. The refrigerant is directed to the indoor unit to lose remaining heat to the indoor space. In an embodiment, the controller 310 is configured to control operation of the four-way valve 108 to cease the defrost cycle when the difference in temperature value (T_{Amb}−T_{Outlet}) is less than the second predetermined temperature value ‘T₂’.

In some embodiments, the controller 310 may be configured to determine whether a predefined time period has elapsed prior to actuation of the four-way valve 108 for a subsequent defrost of the outlet 308 of the evaporator 104. Such predefined time period may eliminate possibility of any false actuation of the four-way valve 108 which may lead to unnecessary heating of the evaporator 104 and power utilization. In a preferred embodiment, the controller 310 is configured to control the operation of the four-way valve 108 to initiate the defrost cycle to heat the outlet 308 of the evaporator 104 only when: (a) the difference in temperature value (T_{Amb}−T_{Outlet}) is greater than the second predetermined temperature value ‘T₂’, (b) the ambient temperature ‘T_{Amb}’ is less than the predefined ambient temperature value ‘T_{P-Amb}’ such as 32° F., and (c) the predefined time period has elapsed with respect to the previous defrost cycle for the outlet 308 of the evaporator 104.

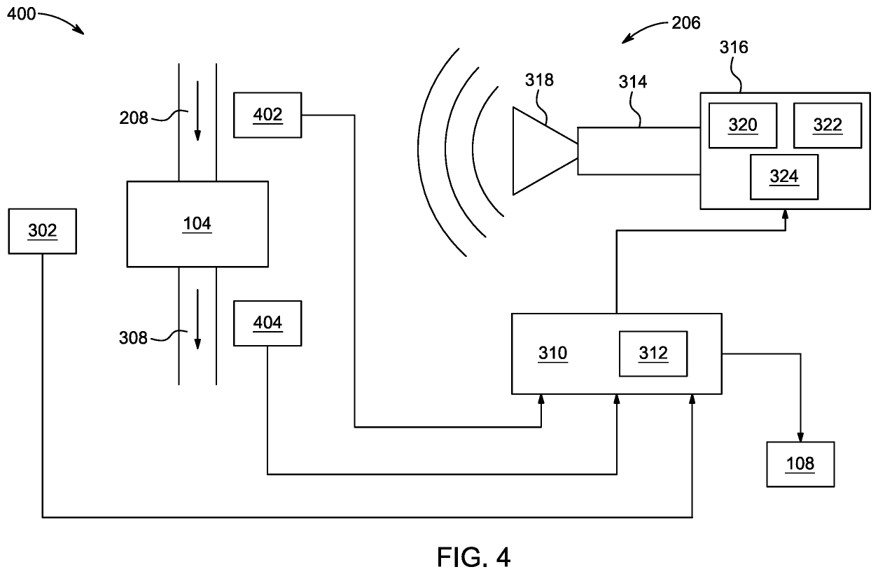

FIG. 4 illustrates a schematic diagram of a defrost control arrangement 400. In an embodiment, the refrigeration device 100 may include a first frost sensor 402 disposed proximal to the inlet 208 of the evaporator 104 and a second frost sensor 404 disposed proximal to the outlet 308 of the evaporator 104. Particularly, as seen in FIG. 4, each of the first sensor 402 and the second sensor 404 are positioned at a predefined distance from the inlet 208 and the outlet 308 of the evaporator 104 respectively to sense corresponding thickness of frost formation. The controller 310 is coupled to each of the first sensor 402 and the second sensor 404. When the first frost sensor 402 senses presence of frost, the controller 310 may be configured to initiate the operation of the microwave module 206 based on an input from the first frost sensor 402 to defrost the inlet 208 of the evaporator 104. Further, based on an input from the second frost sensor 404, the controller 310 may be configured to control operation of the four-way valve 108 to defrost the outlet 308 of the evaporator 104. Upon initiation of defrost cycle, the frost at the inlet 208 or the outlet 308 of the evaporator 104 may be reduced, thereby deactivating the first frost sensor 402 or the second frost sensor 404. As such, the controller 310 may not receive any further input from the first frost sensor 402 or the second frost sensor 404 and hence the defrost cycle may be ceased. Therefore, the refrigeration device 100 of the present disclosure implements controlled defrosting of the evaporator 104.

In some embodiments, frost thickness may be determined using, but limited to, laser displacement gauge measurement, side view photo analysis, digital image processing, optical signal, and neutron radiography conversion measurement.

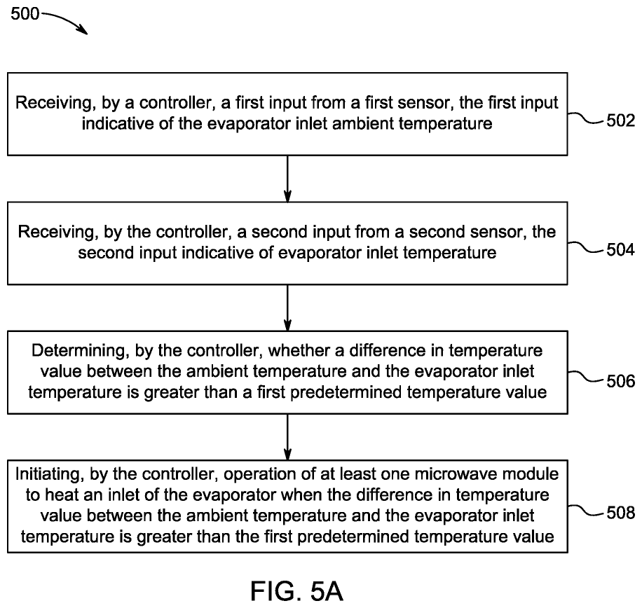

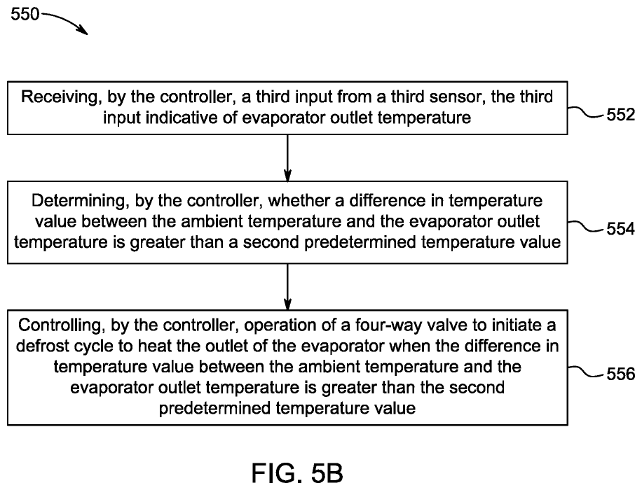

FIG. 5A illustrates a flowchart of a method 500 of operating the refrigeration device 100, according to an embodiment of the present disclosure. The method 500 is described in conjunction with FIG. 1 to FIG. 3. The method 500, at step 502, includes receiving, by the controller 310, a first input from the first sensor 302, where the first input is indicative of the ambient temperature ‘T_{Amb}’.

At step 504, the method 500 includes receiving, by the controller 310, a second input from the second sensor 304, where the second input is indicative of evaporator inlet temperature ‘T_{Inlet}’.

At step 506, the method 500 includes determining, by the controller 310, whether a difference in temperature value between the ambient temperature ‘T_{Amb}’ and evaporator inlet temperature ‘T_{Inlet}’ is greater than the first predetermined temperature value ‘T₁’.

At step 508, the method 500 includes initiating, by the controller 310, operation of the at least one microwave module 206 to heat inlet 208 of the evaporator 104 when the difference in temperature value between the ambient temperature ‘T_{Amb}’ and the evaporator inlet temperature ‘T_{Inlet}’ is greater than the first predetermined temperature value ‘T₁’.

Although not specifically illustrated in FIG. 5A, the method 500 may further include initiating, by the controller 310, operation of the at least one microwave module 206 when the ambient temperature ‘T_{Amb}’ is less than the predefined ambient temperature value ‘ T_{P-Amb}’, such as 32° F. In some embodiments, the method 500 may include determining, by the controller 310, whether a predefined time period has elapsed prior to actuation of the at least one microwave module 206 for a subsequent defrost of the inlet 208 of the evaporator 104. In some embodiments, the method 500 may include receiving, by the controller 310, an input from the first frost sensor 402 disposed proximal to the inlet 208 of the evaporator 104 and initiating, by the controller 310, the operation the at least one microwave module 206 based on the input from the first frost sensor 402 to defrost the inlet 208 of the evaporator 104.

FIG. 5B illustrates a flowchart of a method 550 of operating the refrigeration device 100, according to another embodiment of the present disclosure. The method 550 is described in conjunction with FIG. 1 to FIG. 3. At step 552, the method 550 includes receiving, by the controller 310, a third input from the third sensor 306, where the third input is indicative of the evaporator outlet temperature ‘T_{Outlet}’.

At step 554, the method 550 includes determining, by the controller 310, whether a difference in temperature value between the ambient temperature ‘T_{Amb}’ and the evaporator outlet temperature ‘T_{Outlet}’ is greater than the second predetermined temperature value ‘T₂’.

At step 556, the method 550 includes controlling, by the controller 310, operation of the at least one microwave module 206 to initiate the defrost cycle to heat the outlet 308 of the evaporator 104 when the difference in temperature value between the ambient temperature ‘T_{Amb}’ and the evaporator outlet temperature ‘T_{Outlet}’ is greater than the second predefined temperature value ‘T₂’.

Although not specifically illustrated in FIG. 5B, the method 550 may further include receiving, by the controller 310, an input from the second frost sensor 404 disposed proximal to the outlet 308 of the evaporator 104 and controlling, by the controller 310, the operation of the four-way valve 108 to initiate the defrost cycle to defrost the outlet 308 of the evaporator 104, based on the input from the second frost sensor 404.

While aspects of the present disclosure have been particularly shown and described with reference to the embodiments above, it will be understood by those skilled in the art that various additional embodiments may be contemplated by the modification of the disclosed methods without departing from the spirit and scope of what is disclosed. Such embodiments should be understood to fall within the scope of the present disclosure as determined based upon the claims and any equivalents thereof.

What is claimed is:

1. A refrigeration device comprising:
a circuit comprising an evaporator, a compressor, a condenser, and an expansion valve orderly connected by a refrigerant flow path;
a first sensor configured to sense ambient temperature;
a second sensor configured to sense evaporator inlet temperature;
at least one microwave module disposed proximal to the evaporator and configured to generate microwaves; and
a controller coupled to each of the first sensor, the second sensor, and the at least one microwave module, the controller configured to:
determine whether a difference in temperature value between the ambient temperature and the evaporator inlet temperature is equal to or greater than a first predetermined temperature value; and
initiate operation of the at least one microwave module to heat an inlet of the evaporator when the difference in temperature value between the ambient temperature and the evaporator inlet temperature is equal to or greater than the first predetermined temperature value.

2. The refrigeration device of claim 1, wherein the controller is configured to cease the operation of the at least one microwave module when the difference in temperature value between the ambient temperature and evaporator inlet temperature is less than the first predetermined temperature value.

3. The refrigeration device of claim 1, wherein the first sensor is disposed on a periphery of the evaporator.

4. The refrigeration device of claim 1, wherein the controller is configured to initiate the operation of the at least one microwave module when the ambient temperature is less than a predefined ambient temperature value.

5. The refrigeration device of claim 4, wherein the predefined ambient temperature value is about 32° F.

6. The refrigeration device of claim 1, wherein the at least one microwave module is disposed proximal to the inlet of the evaporator.

7. The refrigeration device of claim 1, wherein the at least one microwave module is disposed around a fan motor of the evaporator.

8. The refrigeration device of claim 1, wherein the at least one microwave module comprises a magnetron, a transformer, a diode, and a capacitor.

9. The refrigeration device of claim 1, wherein the controller is configured to determine whether a predefined time period has elapsed prior to actuation of the at least one microwave module for a subsequent defrost of the inlet of the evaporator.

10. The refrigeration device of claim 1 further comprising:
a third sensor configured to sense evaporator outlet temperature; and
a four-way valve disposed between the evaporator and the compressor;
wherein the controller is coupled to the third sensor and the four-way valve, the controller configured to:
determine whether a difference in temperature value between the ambient temperature and the evaporator outlet temperature is greater than a second predetermined temperature value; and
control operation of the four-way valve to initiate a defrost cycle to heat the outlet of the evaporator when the difference in temperature value between the ambient temperature and the evaporator outlet temperature is greater than the second predetermined temperature value.

11. The refrigeration device of claim 10, wherein the controller is configured to control operation of the four-way valve to cease the defrost cycle when the difference in temperature value between the ambient temperature and the evaporator outlet temperature is less than the second predetermined temperature value.

12. The refrigeration device of claim 1 further comprising a first frost sensor disposed proximal to the inlet of the evaporator, wherein the controller is coupled to the first frost sensor and configured to initiate the operation the at least one microwave module based on an input from the first frost sensor to defrost the inlet of the evaporator.

13. The refrigeration device of claim 10 further comprising a second frost sensor disposed proximal to the outlet of the evaporator, wherein the controller is coupled to the second frost sensor and configured to control operation of the four-way valve to initiate the defrost cycle to defrost the outlet of the evaporator, based on an input from the second frost sensor.

14. The refrigeration device of claim 10, wherein the controller is configured to determine whether a predefined time period has elapsed prior to initiation of the defrost cycle by the four-way valve for a subsequent defrost of the outlet of the evaporator.

15. A method of operating a refrigeration device, the method comprising:
receiving, by a controller, a first input from a first sensor, the first input indicative of ambient temperature;
receiving, by the controller, a second input from a second sensor, the second input indicative of evaporator inlet temperature;
determining, by the controller, whether a difference in temperature value between the ambient temperature and the evaporator inlet temperature is greater than a first predetermined temperature value; and
initiating, by the controller, operation of at least one microwave module to heat an inlet of the evaporator when the difference in temperature value between the ambient temperature and the evaporator inlet temperature is greater than the first predetermined temperature value.

16. The method of claim 15 further comprising initiating, by the controller, operation of the at least one microwave module when the ambient temperature is less than a predefined ambient temperature value.

17. The method of claim 15 further comprising:
receiving, by the controller, an input from a first frost sensor disposed proximal to the inlet of the evaporator; and
initiating, by the controller, the operation the at least one microwave module based on the input from the first frost sensor to defrost the inlet of the evaporator.

18. The method of claim 15 further comprising determining, by the controller, whether a predefined time period has elapsed prior to actuation of the at least one microwave module for a subsequent defrost of the inlet of the evaporator.

19. The method of claim 15 further comprising:
receiving, by the controller, a third input from a third sensor, the third input indicative of evaporator outlet temperature;
determining, by the controller, whether a difference in temperature value between the ambient temperature and the evaporator outlet temperature is greater than a second predetermined temperature value; and
controlling, by the controller, operation of a four-way valve to initiate a defrost cycle to heat the outlet of the evaporator when the difference in temperature value between the ambient temperature and the evaporator outlet temperature is greater than the second predetermined temperature value.

20. The method of claim 19 further comprising:
receiving, by the controller, an input from a second frost sensor disposed proximal to the outlet of the evaporator; and
controlling, by the controller, the operation of the four-way valve to initiate the defrost cycle to defrost the outlet of the evaporator, based on the input from the second frost sensor.
